(19) United States
(12) Patent Application Publication
(10) Pub. No.: US 2026/0062531 A1
(43) Pub. Date: Mar. 5, 2026

(54) RECYCLE METHOD OF POLYESTER FABRIC

(71) Applicant: NAN YA PLASTICS CORPORATION, Taipei City (TW)

(72) Inventors: Ching-Yao Yuan, Taipei City (TW); Chung Yu Chen, Taipei City (TW); Chung-Chi Su, Taipei City (TW); Mong-Chen Chang, Taipei City (TW); Zhang-Jian Huang, Taipei City (TW)

(73) Assignee: NAN YA PLASTICS CORPORATION, Taipei City (TW)

(21) Appl. No.: 18/914,272

(22) Filed: Oct. 14, 2024

(30) Foreign Application Priority Data
Aug. 30, 2024 (TW) 113132898

(51) Int. Cl. C08J 11/08; D06P 5/13

(52) U.S. Cl. CPC C08J 11/08; D06P 5/137; C08J 2367/02

(57) ABSTRACT

The disclosure provides a recycle method of a polyester fabric, which includes the following steps. A decolorization treatment is performed on the polyester fabric to form a decolorized polyester fabric. The decolorized polyester fabric is mixed with a thickening material to form an initial feed. A liquid state polymerization is performed on the initial feed to form a liquid state polymer product. The liquid state polymer product is refluxed to be mixed with the initial feed to form an intermediate feed. The liquid state polymerization is performed on the intermediate feed to form a final polymer product.

### CROSS-REFERENCE TO RELATED APPLICATION

This application claims the priority benefit of Taiwan application serial no. 113132898, filed on Aug. 30, 2024. The entirety of the above-mentioned patent application is hereby incorporated by reference herein and made a part of this specification.

### BACKGROUND

### Technical Field

The disclosure relates to a recycle method of a fabric, and more particularly, to a recycle method of a polyester fabric.

### Description of Related Art

A conventional physical (mechanical) recycle method of a waste polyester (e.g., polyethylene terephthalate (PET)) fabric is to increase intrinsic viscosity (IV) thereof by mixing it with PET bottle flakes, so as to facilitate subsequent spinning processing. However, since an IV difference between the fabric and the PET bottle flakes is too large, even after mixing by a mixer and an extruder, the mixing is only macroscopic, and microscopic uniformity is not good. In addition, the IV of the fabric and the PET bottle flakes will decrease after the thermal history, resulting in poor IV stability (excessive variation) of PET fabric mechanical recycle pellets, and quality of IV may not be effectively controlled, resulting in poor subsequent spinning processability. For example, strength of silk is insufficient, and it breaks easily.

### SUMMARY

The disclosure provides a recycle method of a polyester fabric, which may improve uniformity of intrinsic viscosity of recycled polyester.

A recycle method of a polyester fabric in the disclosure includes the following steps. A decolorization treatment is performed on the polyester fabric to form a decolorized polyester fabric. The decolorized polyester fabric is mixed with a thickening material to form an initial feed. A liquid state polymerization is performed on the initial feed to form a liquid state polymer product. The liquid state polymer product is refluxed to be mixed with the initial feed to form an intermediate feed. The liquid state polymerization is performed on the intermediate feed to form a final polyester product.

In an embodiment of the disclosure, a weight ratio of the decolorized polyester fabric to the thickening material is 5:95 to 80:20.

In an embodiment of the disclosure, a temperature of the liquid state polymerization is 210° C. to 290° C., and a pressure of the liquid state polymerization is 0.1 torr to 5.0 torr.

In an embodiment of the disclosure, a holding time for performing the liquid state polymerization on the decolorized polyester fabric and the thickening material is about 5 minutes to 200 minutes.

In an embodiment of the disclosure, intrinsic viscosity of the final polyester product is above 0.60.

In an embodiment of the disclosure, a standard deviation of intrinsic viscosity of the final polyester product is less than 0.0036.

In an embodiment of the disclosure, a CIELAB color definition of the final polyester product is an L value of above 70, an a value of −3.0 to +3.0, and a b value of −10.0 to +10.0.

In an embodiment of the disclosure, a weight ratio of an reflux amount of the liquid state polymer product to a feeding amount of the initial feed is 5:1 to 50:1.

In an embodiment of the disclosure, the feeding amount of the initial feed is equal to a discharging amount of the final polymer product.

In an embodiment of the disclosure, the polyester fabric includes a gray fabric, a dye-containing colored fabric, or a fabric containing a surface treatment agent.

In an embodiment of the disclosure, intrinsic viscosity (IV) of the polyester fabric is 0.50 to 0.70.

In an embodiment of the disclosure, intrinsic viscosity of the decolorized polyester fabric is 0.45 to 0.65.

In an embodiment of the disclosure, a CIELAB color definition of the decolorized polyester fabric is an L value of above 85, an a value of −5.0 to +5.0, and a b value of −15.0 to +15.0.

In an embodiment of the disclosure, the decolorization treatment is performed using solvent extraction or aqueous solution extraction.

In an embodiment of the disclosure, the thickening material is PET bottle flakes, and intrinsic viscosity of the PET bottle flakes is 0.75 to 0.95.

In an embodiment of the disclosure, the thickening material is PET bottle flakes, and a CIELAB color definition of the PET bottle flakes is an L value of above 80, an a value of −2.0 to +2.0, and a b value of −4.0 to +4.0.

Based on the above, in the recycle method of the polyester fabric in the disclosure, the liquid state polymer product is refluxed multiple times to repeat the liquid state polymerization, which may not only improve IV while improving IV uniformity, but also improve hue performance of the final polymer product.

### BRIEF DESCRIPTION OF THE DRAWINGS

FIG. 1 is a schematic flow chart of a recycle method of a polyester fabric according to an embodiment of the disclosure.

FIG. 2 is a schematic cross-sectional view of a liquid state polymerization unit according to an embodiment of the disclosure.

### DETAILED DESCRIPTION OF DISCLOSED EMBODIMENTS

Hereinafter, embodiments of the disclosure will be described in detail. However, the embodiments are exemplary, and the disclosure is not limited thereto.

In the present specification, a range represented by “a numerical value to another numerical value” is a schematic representation for avoiding listing all of the numerical values in the range in the specification. Therefore, the recitation of a specific numerical range covers any numerical value in the numerical range and a smaller numerical range defined by any numerical value in the numerical range, as is the case with the any numerical value and the smaller numerical range stated explicitly in the specification.

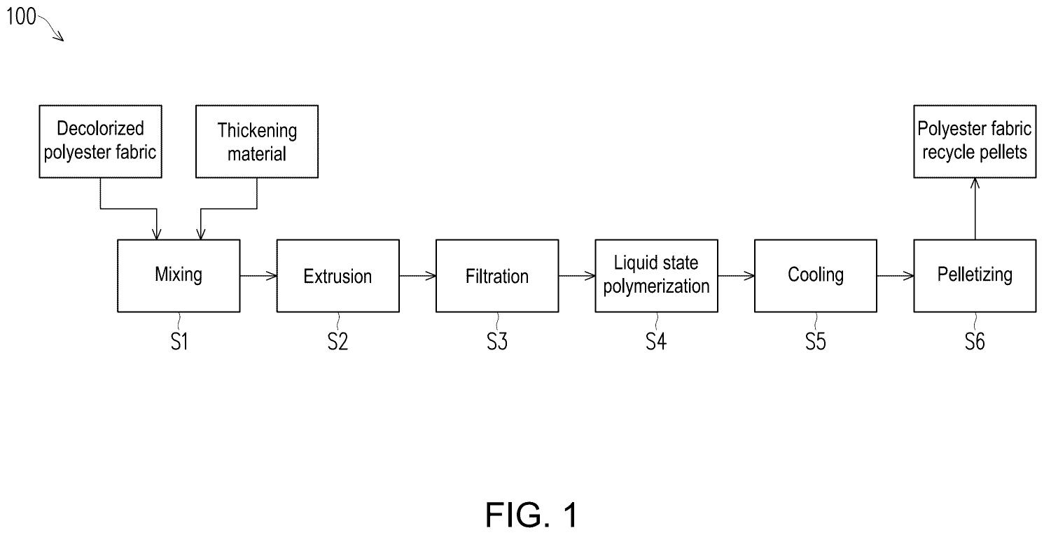

FIG. 1 is a schematic flow chart of a recycle method 100 of a polyester fabric according to an embodiment of the disclosure.

Referring to FIG. 1, in step S1, first, a decolorized polyester fabric is mixed with a thickening material, so that the thickening material is roughly evenly dispersed in the decolorized polyester fabric to form an initial feed. A weight ratio of the decolorized polyester fabric to the thickening material may be 5:95 to 80:20. For example, the weight ratio of the decolorized polyester fabric to the thickening material is 1:4, 1:2, or 1:1. The decolorized polyester fabric may be a waste polyester fabric after a decolorization treatment. For example, the waste polyester fabric is a waste PET fabric, and the waste polyester fabric after the decolorization treatment is a decolorized PET fabric, but polyester in the disclosure is not limited to PET. In some embodiments, the waste PET fabric includes gray fabrics, dye-containing colored fabrics, or fabrics containing surface treatment agents. In some embodiments, the surface treatment agent contained in the waste PET fabric includes polyurethane (PU), acrylic, thermoplastic polyester elastomer (TPEE), or a combination thereof.

In some embodiments, intrinsic viscosity (IV) of the waste PET fabric is about 0.50 to 0.70. In some embodiments, intrinsic viscosity of the decolorized PET fabric is about 0.45 to 0.65 due to a thermal history of the decolorization treatment. In some embodiments, the decolorized PET fabric has a hue (CIELAB color definition) with an L value of above 85, an a value of −5.0 to 5.0, and a b value of −15.0 to +15.0.

The decolorization treatment is to remove impurities such as dyes from the waste polyester fabric to achieve a decolorization effect. The decolorization treatment may be performed using solvent extraction or aqueous solution extraction, which respectively use solvents and aqueous solutions to extract the dyes or destroy chromophoric functional groups to achieve the decolorization effect.

The solvents used in the solvent extraction may include aromatic hydrocarbon solvents, alcohol ether solvents, benzyl alcohol solvents, alcohol solvents, or amide solvents. In some embodiments, the aromatic hydrocarbon solvent includes benzene, toluene, or xylene. In some embodiments, the alcohol ether solvent includes propylene glycol monomethyl ether, ethylene glycol monobutyl ether, diethylene glycol monobutyl ether, or anisole. In some embodiments, the alcohol solvent includes ethylene glycol, butanol, pentanol, or hexanol. In some embodiments, the amide solvent includes dimethylformamide, dimethylacetamide, or N-methylpyrrolidone. In some embodiments, the above solvent includes propylene glycol monomethyl ether, anisole, dimethylacetamide, dimethylformamide, ethylene glycol, N-methylpyrrolidone, or a combination thereof.

The aqueous solution used in the aqueous solution extraction may contain alkali, surfactant, reducing agents, oxidizing agents, or a combination thereof. In some embodiments, the aqueous solution used in the aqueous solution extraction may contain sodium hydroxide, sodium hypochlorite, calcium hypochlorite, sodium thiosulfate, sodium dithionite, thiourea dioxide, or a combination thereof.

The thickening material may be a material with greater intrinsic viscosity than the decolorized polyester fabric. For example, the thickening material is PET bottle flakes, but the disclosure is not limited thereto. In some embodiments, intrinsic viscosity of the PET bottle flakes is about 0.75 to 0.95. In some embodiments, the PET bottle flakes have a hue with an L value of about 80 or more, an a value of about −2.0 to +2.0, and a b value of about −4.0 to +4.0.

Next, in step S2, the decolorized polyester fabric and the thickening material (i.e., the initial feed) that are mixed are entered into an extruder for extrusion to generate a molten mixture of the decolorized polyester fabric and the thickening material. The extruder may be equipped with a single screw or a twin screw, and the extrusion may be performed at a temperature higher than a room temperature. In some embodiments, the extrusion is performed at an extrusion temperature of 210° C. to 290° C., such as 220° C. to 250° C., 250° C. to 280° C., or 240° C. to 270° C. In some embodiments, the extrusion is performed for an extrusion time of 0.3 minutes to 30 minutes, such as 1 minute to 10 minutes, 10 minutes to 20 minutes, or 15 minutes to 25 minutes.

Next, in step S3, the molten mixture of the decolorized polyester fabric and the thickening material is maintained at the extrusion temperature for filtration to further filter the impurities and generate a filtered molten mixture. The molten mixture of the decolorized polyester fabric and the thickening material may be filtered through a screen. In some embodiments, the screen has screen pores of 30 μm to 120 μm (e.g., 40 μm to 100 μm or 50 μm to 80 μm), but the disclosure is not limited thereto.

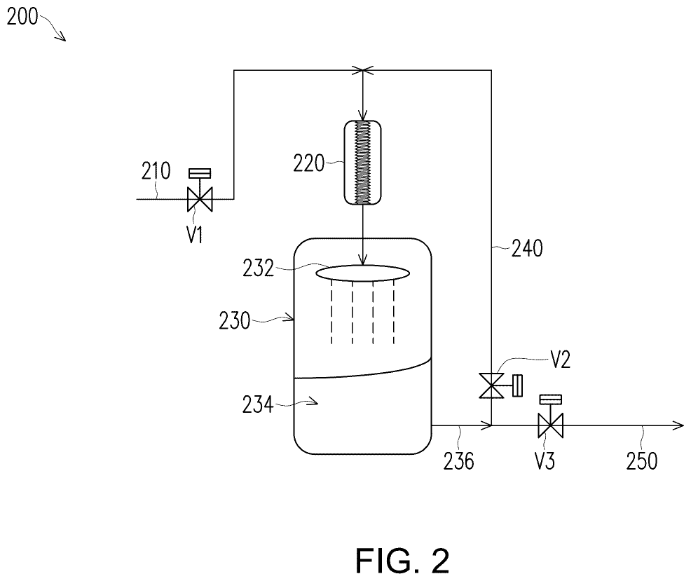

Next, in step S4, the filtered molten mixture enters a liquid state polymerization unit for a liquid state polymerization to form a liquid state polymer product. FIG. 2 is a schematic cross-sectional view of a liquid state polymerization unit 200 according to an embodiment of the disclosure. The liquid state polymerization unit 200 may include an input channel 210, a static mixer 220, a liquid state polymerization tank 230, a reflux channel 240, and an output channel 250. The input channel 210 may be communicated to an inlet of the static mixer 220. An outlet of the static mixer 220 may be communicated to an inlet of the liquid state polymerization tank 230. An outlet of the liquid state polymerization tank 230 may be communicated to an input end of the reflux channel 240 and the output channel 250, and an output end of the reflux channel 240 may be communicated to the inlet of the static mixer 220.

The liquid state polymerization unit 200 may further include multiple valves V1, V2, and V3. For example, the valve V1 may be disposed on the input channel 210, the valve V2 may be disposed on the reflux channel 240, and the valve V3 may be disposed on the output channel 250 for controlling a flow rate in each of the channels.

The filtered molten mixture may enter the liquid state polymerization unit 200 through the input channel 210. Then, the filtered molten mixture may enter the static mixer 220 from the input channel 210 for static mixing. Next, the filtered molten mixture may leave the static mixer 220 and enter the liquid state polymerization tank 230 for the liquid state polymerization to form the liquid state polymer product. Then, the liquid state polymerization product may leave the liquid state polymerization tank 230 and be refluxed to the static mixer 220 through the reflux channel 240 to be mixed with other filtered molten mixtures or liquid state polymerization products to form an intermediate feed. In addition, the liquid state polymerization product may leave the liquid state polymerization unit 200 through the output channel 250 as a final polyester product. A weight ratio of a reflux amount of the liquid state polymerization product refluxed to the static mixer 220 and an feeding amount of the filtered molten mixture entering the static mixer 220 may be 5:1 to 50:1, such as 10:1 to 40:1 or 20:1 to 30:1. Through a reflux mechanism of the reflux channel 240, the liquid state polymerization product may be refluxed to the static mixer 220 multiple times to be mixed with other filtered molten mixtures or liquid state polymerization products, and enter the liquid state polymerization tank 230 multiple times for the liquid state polymerization, so that the decolorized polyester fabric and the thickening material may be mixed evenly at a microscopic level, and the final polyester product may have stable and uniform (small variation) IV, thus improving processability and quality of subsequent spinning.

The liquid state polymerization tank 230 may include a sprayer 232, a holding tank 234, and a reflux pipe 236. The sprayer 232 may have an aperture of 0.01 mm to 10 mm (e.g., 0.05 mm to 5.0 mm). Through the sprayer 232, the filtered molten mixture and the liquid state polymer product may be sprayed more uniformly into the holding tank 234 of the liquid state polymerization tank 230, and then the liquid state polymerization is performed thereon in the holding tank 234 to be then discharged through the reflux pipe 236 to the reflux channel 240 and the output channel 250.

During an operation of the liquid state polymerization unit 200, the liquid state polymerization unit 200 may be maintained at a temperature between 210° C. and 290° C. (e.g., 220° C. and 280° C.), and the liquid state polymerization tank 230 may be maintained at a pressure of 0.1 torr. to 5.0 torr (e.g., 0.2 torr to 3.0 torr). In some embodiments, the holding time of the liquid state polymerization for the decolorized polyester fabric and the thickening material is about 5 minutes to 200 minutes (e.g., 10 minutes to 100 minutes). In some embodiments, during the operation of the liquid state polymerization unit 200, the filtered molten mixture may be continuously fed to the liquid state polymerization unit 200, and the final polyester product may be continuously discharged from the liquid state polymerization unit 200. In some embodiments, the feeding amount of the filtered molten mixture is approximately equal to a discharging amount of the final polyester product.

Next, in step S5, the final polyester product leaving the liquid state polymerization unit 200 may be cooled. Next, in step S6, the cooled final polyester product may be pelletized to generate polyester fabric mechanical recycle pellets for subsequent use. In some embodiments, IV of the polyester fabric mechanical recycle pellets is above 0.60, an IV standard deviation is less than 0.0036, the L value is above 70, the a value is −3.0 to +3.0, and the b value is −10.0 to +10.0, the polyester fabric mechanical recycle pellets may be used for spinning, weaving, dyeing and finishing into fabrics, thus forming a waste fabric recycle system.

Hereinafter, the above recycle method of the polyester fabric provided in the disclosure will be described in detail through examples. However, the following examples are not intended to limit the disclosure.

### <Preparation of Solvent-Decolorized PET Fabric Using Solvent Extraction>

The waste PET fabric of 108.7 kg was taken, and the intrinsic viscosity thereof was about 0.55, the L value was about 22.4, the a value was about 2.7, and the b value was about 2.8. The dye accounted for 8.7 kg, and PET accounted for 100 kg. Next, it was cut into 3 cm square and placed in a stirring tank of 1 m³. Next, dimethylacetamide (DMAc) of 600 kg was poured into the stirring tank, heated to 130° C. and stirred for 30 minutes, and then filtered through a filter of 1 cm to separate DMAc. Then, the fabric was put back into the stirring tank and DMAc of 500 kg was poured into the stirring tank to be heated to 130° C. and stirred 30 minutes, and then filtered to separate DMAc, and this operation was repeated 4 times. Then, the fabric was dried in an oven at 120° C. and 5 torr for 6 hours. The dried decolorized PET fabric weighed 96.2 kg and had the intrinsic viscosity of about 0.48, the L value of about 90.1, the a value of about 0.9, and the b value of about 3.2. In this manner, a solvent-decolorized PET fabric of 962 kg was prepared.

### <Preparation of Aqueous Solution-Decolorized PET Fabric Using Aqueous Solution Extraction>

The waste PET fabric of 108.7 kg was taken, and the intrinsic viscosity thereof was about 0.55, the L value was about 22.4, the a value was about 2.7, and the b value was about 2.8. The dye accounted for 8.7 kg, and PET accounted for 100 kg. Next, it was cut into 3 cm square and placed in a stirring tank of 2 m³. Next, water of 1,000 kg, NaOH of 5 kg, and sodium thiosulfate of 3 kg were poured into the stirring tank and heated to 137° C. The temperature was kept for 30 minutes, and the tank was maintained at a pressure of 5 bar with nitrogen, and then the water was drained. This operation was repeated once. Then, water of 1,000 kg and calcium hypochlorite of 3 kg were added and heated to 137° C. The temperature was kept for 30 minutes, and the tank was maintained at the pressure of 5 bar with nitrogen, and then the water was drained. Next, the fabric was dried in the oven at 120° C. and 5 torr for 6 hours. The dried decolorized PET fabric weighed 97.8 kg and had the intrinsic viscosity of about 0.50, the L value of about 89.0, the a value of about 1.2, and the b value of about 8.4. In this manner, an aqueous solution-decolorized PET fabric of 978 kg was prepared.

### <PET Bottle Flakes>

A used PET bottle was taken, and a cap and a label were removed to be broken into 3 cm squares. Then it was washed with the aqueous solution containing surfactant, and finally it was washed with clean water and then put in the oven to dry at 105° C. for 6 hours. The obtained PET bottle flakes have the intrinsic viscosity of about 0.81, the L value of about 85, the a value of about 0.7, and the b value of about 1.4.

### Example 1

Referring to both FIGS. 1 and 2, the solvent-decolorized PET fabric of 200 kg was taken to be mixed with the PET bottle flakes of 800 kg to form the initial feed. The initial feed was injected into the twin-screw extruder at a flow rate of 6 kg/min, and the temperature was 260° C. The extruded molten PET was filtered through a mesh of 60 μm, and the filtered molten PET then entered the liquid state polymerization unit 200 for the liquid state polymerization to form the liquid state polymer product, such as liquid state polymerization PET.

In more detail, after the filtered molten PET (the feeding amount was about 6 kg/min) entered the static mixer 220, it may be mixed with the liquid state polymerization PET refluxed through the reflux channel 240 (the reflux amount was about 60 kg/min) to the static mixer 220. After the two fluids of the filtered molten PET and the liquid state polymerization PET were mixed by the static mixer 220, they were then sprayed into the holding tank 234 through the sprayer 232 with an aperture of 1.0 mm. The temperature in the holding tank 234 was 265° C., and the pressure was 0.5 torr. A weight of the filtered molten PET and the liquid state polymerization PET retained in the holding tank 234 was approximately 150 kg. After multiple refluxes and liquid state polymerization, the final polyester product was discharged from the liquid state polymerization tank 230 at 6 kg/min. The holding time of the filtered molten PET in the holding tank 234 was about 25 minutes. Subsequently, the final polyester product was cooled and solidified, and then made into PET recycle pellets, and a quality analysis was performed on the PET recycle pellets. Results of the quality analysis of the PET recycle pellets were measured to be IV of about 0.65, the IV standard deviation of about 0.0020, the L value of about 78, the a value of about 0.9, and the b value of about 2.8, which means that IV has been effectively improved, and the IV distribution has high stability and good hue.

### Example 2

A method substantially the same as that of Example 1 was used to manufacture the PET recycle pellets. A main difference was that the feeding amount and the reflux amount of the solvent-decolorized PET fabric and the PET bottle flakes were changed, and the results of the quality analysis of the PET recycle pellets measured in Example 2 were shown in Table 1.

### Example 3

The method substantially the same as that of Example 1 was used to manufacture the PET recycle pellets. A main difference was that the feeding amount, the reflux amount, the temperature of the liquid state polymerization, and the pressure of the liquid state polymerization of the solvent-decolorized PET fabric and the PET bottle flakes were changed, and the results of the quality analysis of the PET recycle pellets measured in Example 3 were shown in Table 1.

### Examples 4 to 6

The method substantially the same as those of Examples 1 to 3 was used to manufacture the PET recycle pellets in Examples 4 to 6 respectively. A main difference was that the aqueous solution-decolorized PET fabric was used instead of the solvent-decolorized PET fabric, and the results of the quality analysis of the PET recycle pellets measured in Examples 4 to 6 were shown in Table 1.

The preparation methods and the test results of the above Examples 1 to 6 were summarized in Table 1 below.

TABLE 1

| | | | Example | | | | | |
|---|---|---|---|---|---|---|---|---|
| Quality analysis | | | Example 1 | Example 2 | Example 3 | Example 4 | Example 5 | Example 6 |
| Waste PET | IV | | 0.55 | | | 0.55 | | |
| fabric | Hue | L(%) | 22.4 | | | 22.4 | | |
| | | a | 2.7 | | | 2.7 | | |
| | | b | 2.8 | | | 2.8 | | |
| PET fabric | IV | | 0.48 | | | 0.50 | | |
| after | Hue | L(%) | 90.1 | | | 89.0 | | |
| decolorization | | a | 0.9 | | | 1.2 | | |
| | | b | 3.2 | | | 8.4 | | |
| PET bottle | IV | | 0.81 | | | 0.81 | | |
| flakes | Hue | L(%) | 85.0 | | | 85.0 | | |
| | | a | 0.7 | | | 0.7 | | |
| | | b | 1.4 | | | 1.4 | | |
| Liquid state | Feeding | Decolorized | 1.2 | 2.0 | 3.0 | 1.2 | 2.0 | 3.0 |
| polymerization | amount | PET | | | | | | |
| | (kg/min) | fabric | | | | | | |
| | | PET bottle | 4.8 | 4.0 | 3.0 | 4.8 | 4.0 | 3.0 |
| | | flakes | | | | | | |
| | | Total | 6.0 | 6.0 | 6.0 | 6.0 | 6.0 | 6.0 |
| | Filter mesh (μm) | | 60 | 60 | 60 | 60 | 60 | 60 |
| | Sprayer aperture (mm) | | 1.0 | 1.0 | 1.0 | 1.0 | 1.0 | 1.0 |
| | Reflux amount (kg/min) | | 60 | 120 | 300 | 60 | 120 | 300 |
| | Static mixer | | having | | | having | | |
| | (Reflux amount/feeding | | 10 | 20 | 50 | 10 | 20 | 50 |
| | amount) weight ratio | | | | | | | |
| | Temperature (° C.) | | 265 | 265 | 275 | 265 | 265 | 275 |
| | Pressure (torr) | | 0.5 | 0.5 | 0.4 | 0.5 | 0.5 | 0.4 |
| | Holding time (min) | | 25 | 25 | 25 | 25 | 25 | 25 |
| Quality | Polymerization | IV | 0.65 | 0.61 | 0.64 | 0.68 | 0.64 | 0.65 |
| analysis of | quality | Standard | 0.0020 | 0.0025 | 0.0034 | 0.0018 | 0.0024 | 0.0031 |
| PET recycle | | deviation | | | | | | |
| pellets | Hue | L(%) | 78.0 | 76.4 | 74.8 | 75.3 | 72.7 | 70.1 |
| | | a | 0.9 | 1.2 | 1.4 | 1.1 | 1.7 | 2.4 |
| | | b | 2.8 | 3.2 | 4.1 | 5.2 | 6.8 | 8.4 |

### Comparative Example 1

The method substantially the same as that of Example 1 was used to manufacture the PET recycle pellets. A main difference was that the liquid state polymerization unit 200 was not equipped with the static mixer 220 and the reflux channel 240. In other words, the filtered molten PET in the input channel 210 directly entered the liquid state polymerization tank 230 for the liquid state polymerization, and the liquid state polymerization PET flowing out from the liquid state polymerization tank 230 directly left the liquid state polymerization unit 200 from the output channel 250 and would not flow back to the liquid state polymerization tank 230 for the liquid state polymerization. Therefore, the weight ratio of the reflux amount/feeding amount was 0.

### Comparative Example 2

The method substantially the same as that of Example 2 was used to manufacture the PET recycle pellets. A main difference was that the liquid state polymerization unit 200 was not equipped with the static mixer 220 and the reflux channel 240. In other words, the filtered molten PET in the input channel 210 directly entered the liquid state polymerization tank 230 for the liquid state polymerization, and the weight ratio of the reflux amount/feeding amount was 0.

### Comparative Example 3

The method substantially the same as that of Example 3 was used to manufacture the PET recycle pellets. A main difference was that the liquid state polymerization unit 200 was not equipped with the static mixer 220, and the weight ratio of the reflux amount/feeding amount was 1.0.

### Comparative Example 4

The method substantially the same as that of Example 4 was used to manufacture the PET recycle pellets. A main difference was that the liquid state polymerization unit 200 was not equipped with the static mixer 220 and the reflux channel 240. In other words, the filtered molten PET in the input channel 210 directly entered the liquid state polymerization tank 230 for the liquid state polymerization, and the weight ratio of the reflux amount/feeding amount was 0.

### Comparative Example 5

The method substantially the same as that of Example 5 was used to manufacture the PET recycle pellets. A main difference was that the liquid state polymerization unit 200 was not equipped with the static mixer 220 and the reflux channel 240. In other words, the filtered molten PET in the input channel 210 directly entered the liquid state polymerization tank 230 for the liquid state polymerization, and the weight ratio of the reflux amount/feeding amount was 0.

### Comparative Example 6

The method substantially the same as that of Example 6 was used to manufacture the PET recycle pellets. A main difference was that the liquid state polymerization unit 200 was not equipped with the static mixer 220, and the weight ratio of the reflux amount/feeding amount was 1.0.

Preparation methods and test results of the above Comparative Examples 1 to 6 were summarized in Table 2 below.

TABLE 2

| | | | Comparative example | | | | | |
|---|---|---|---|---|---|---|---|---|
| | | | Comparative | Comparative | Comparative | Comparative | Comparative | Comparative |
| Quality analysis | | | example 1 | example 2 | example 3 | example 4 | example 5 | example 6 |
| Waste PET | IV | | 0.55 | | | 0.55 | | |
| fabric | Hue | L(%) | 22.4 | | | 22.4 | | |
| | | a | 2.7 | | | 2.7 | | |
| | | b | 2.8 | | | 2.8 | | |
| PET fabric | IV | | 0.48 | | | 0.50 | | |
| after | Hue | L(%) | 90.1 | | | 89.0 | | |
| decolorization | | a | 0.9 | | | 1.2 | | |
| | | b | 3.2 | | | 8.4 | | |
| PET bottle | IV | | 0.81 | | | 0.81 | | |
| flakes | Hue | L(%) | 85.0 | | | 85.0 | | |
| | | a | 0.7 | | | 0.7 | | |
| | | b | 1.4 | | | 1.4 | | |
| Liquid state | Feeding | Decolorized | 1.2 | 2.0 | 3.0 | 1.2 | 2.0 | 3.0 |
| polymerization | amount | PET | | | | | | |
| | (kg/min) | fabric | | | | | | |
| | | PET bottle | 4.8 | 4.0 | 3.0 | 4.8 | 4.0 | 3.0 |
| | | flakes | | | | | | |
| | | Total | 6.0 | 6.0 | 6.0 | 6.0 | 6.0 | 6.0 |
| | Filter mesh (μm) | | 60 | 60 | 60 | 60 | 60 | 60 |
| | Sprayer aperture (mm) | | 1.0 | 1.0 | 1.0 | 1.0 | 1.0 | 1.0 |
| | Reflux amount (kg/min) | | 0 | 0 | 6.0 | 0 | 0 | 6.0 |
| | Static mixer | | none | | | none | | |
| | (Reflux amount/feeding | | 0 | 0 | 1.0 | 0 | 0 | 1.0 |
| | amount) weight ratio | | | | | | | |
| | Temperature (° C.) | | 265 | 265 | 275 | 265 | 265 | 275 |
| | Pressure (torr) | | 0.5 | 0.5 | 0.4 | 0.5 | 0.5 | 0.4 |
| | Holding time (min) | | 25 | 25 | 25 | 25 | 25 | 25 |
| Quality | Polymerization | IV | 0.64 | 0.59 | 0.64 | 0.65 | 0.62 | 0.63 |
| analysis of | quality | Standard | 0.0074 | 0.0125 | 0.0147 | 0.0041 | 0.0092 | 0.0133 |
| PET recycle | | deviation | | | | | | |
| pellets | Hue | L(%) | 77.2 | 75.2 | 71.2 | 72.3 | 69.9 | 67.7 |
| | | a | 1.1 | 1.4 | 1.8 | 1.7 | 2.9 | 3.6 |
| | | b | 3.0 | 3.8 | 5.4 | 6.6 | 8.1 | 10.9 |

According to the results of the quality analysis in Table 1, the IV standard deviations of the PET recycle pellets in Examples 1 to 6 were all less than 0.0036, indicating that IV stability thereof was high, and IV may reach more than 0.60. In addition, the L values in Examples 1 to 6 were all greater than 70, the a values were all less than 2.5, and the b values were all less than 8.5, indicating that the hue was good.

According to the results of the quality analysis in Table 2, the IV standard deviations of the PET recycle pellets in Comparative Examples 1 to 6 were all greater than 0.004, indicating that the IV distribution thereof may not be stabilized, and IV may not be effectively controlled. In addition, the L values in Examples 1 to 6 were respectively greater than the L values in Comparative Examples 1 to 6, the a values in Examples 1 to 6 were respectively less than the a values in Comparative Examples 1 to 6, and the b values in Examples 1 to 6 were respectively less than the b values in Comparative Examples 1 to 6, which means that hue performance in Examples 1 to 6 was significantly better than that in Comparative Examples 1 to 6.

Based on the above, in the recycle method of the polyester fabric in the disclosure, by refluxing the liquid state polymer product multiple times to repeat the liquid state polymerization, it may not only increase IV while effectively stabilizing the IV distribution to improve the IV uniformity, but also improve the hue performance of recycled polyester.

What is claimed is:

1. A recycle method of a polyester fabric, comprising:
performing a decolorization treatment on the polyester fabric to form a decolorized polyester fabric;
mixing the decolorized polyester fabric with a thickening material to form an initial feed;
performing a liquid state polymerization on the initial feed to form a liquid state polymer product;
refluxing the liquid state polymer product to mix with the initial feed to form an intermediate feed; and
performing the liquid state polymerization on the intermediate feed to form a final polyester product.

2. The method according to claim 1, wherein a weight ratio of the decolorized polyester fabric to the thickening material is 5:95 to 80:20.

3. The method according to claim 1, wherein a temperature of the liquid state polymerization is 210° C. to 290° C., and a pressure of the liquid state polymerization is 0.1 torr to 5.0 torr.

4. The method according to claim 1, wherein a holding time for performing the liquid state polymerization on the decolorized polyester fabric and the thickening material is about 5 minutes to 200 minutes.

5. The method according to claim 1, wherein intrinsic viscosity of the final polyester product is above 0.60.

6. The method according to claim 1, wherein a standard deviation of intrinsic viscosity of the final polyester product is less than 0.0036.

7. The method according to claim 1, wherein a CIELAB color definition of the final polyester product is an L value of above 70, an a value of −3.0 to +3.0, and a b value of −10.0 to +10.0.

8. The method according to claim 1, wherein a weight ratio of an reflux amount of the liquid state polymer product to a feeding amount of the initial feed is 5:1 to 50:1.

9. The method according to claim 8, wherein the feeding amount of the initial feed is equal to a discharging amount of the final polymer product.

10. The method according to claim 1, wherein the polyester fabric comprises a gray fabric, a dye-containing colored fabric, or a fabric containing a surface treatment agent.

11. The method according to claim 1, wherein intrinsic viscosity (IV) of the polyester fabric is 0.50 to 0.70.

12. The method according to claim 1, wherein intrinsic viscosity of the decolorized polyester fabric is 0.45 to 0.65.

13. The method according to claim 1, wherein a CIELAB color definition of the decolorized polyester fabric is an L value of above 85, an a value of −5.0 to +5.0, and a b value of −15.0 to +15.0.

14. The method according to claim 1, wherein the decolorization treatment is performed using solvent extraction or aqueous solution extraction.

15. The method according to claim 1, wherein the thickening material is PET bottle flakes, and intrinsic viscosity of the PET bottle flakes is 0.75 to 0.95.

16. The method according to claim 1, wherein the thickening material is PET bottle flakes, and a CIELAB color definition of the PET bottle flakes is an L value of above 80, an a value of −2.0 to +2.0, and a b value of −4.0 to +4.0.
